(19) United States
(12) Patent Application Publication
(10) Pub. No.: US 2019/0277650 A1
(43) Pub. Date: Sep. 12, 2019

(54) NAVIGATION USING CONTEXTUAL ANALYSIS

(71) Applicant: HONDA MOTOR CO., LTD., Tokyo (JP)

(72) Inventors: Jenny LE, Santa Clara, CA (US); Rajesh Reddy, Saratoga, CA (US); Boris Hernan Polania Castro, Cupertino, CA (US); Ryan Lacross, San Jose, CA (US)

(21) Appl. No.: 15/918,439

(22) Filed: Mar. 12, 2018

(51) Int. Cl. G01C 21/36; G06F 17/30; G06F 7/08

(52) U.S. Cl. CPC G01C 21/3682; G06F 17/30864; G01C 21/3608; G01C 21/3629; G06F 7/08

(57) ABSTRACT

A system and method of providing navigation directions to a driver of a vehicle include receiving a search request to locate a type of establishment, generating a list of a plurality of establishments matching the type of establishment, displaying selectable directions to the plurality of establishments, receiving a user selection of a selectable direction to a desired establishment from the list of the plurality of establishments, and displaying the selectable direction to the desired establishment.

### BACKGROUND

On-board vehicular communication systems allow drivers to communicate with one or more call centers via wireless networks, such as CDMA, GSM, and LTE networks. Drivers may contact the call centers during emergencies, summon road-side assistance, ask for navigation directions, and request vehicle diagnostics. Many on-board systems provide audio interfaces to allow drivers to communicate with the call centers. Additionally, drivers may also rely on textual input/output or other methods of communication.

To better assist drivers, the on-board systems may transmit global positioning system (GPS) data to the call centers to relay the vehicles' location. The GPS data may allow the call centers to provide faster road-side assistance and navigation directions, help locate lost vehicles, and offer recommendations for attractions and amenities in the vicinity of the vehicles.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

Aspects of the present disclosure include a method of providing navigation directions to a driver of a vehicle including receiving a search request to locate a type of establishment, generating a list of a plurality of establishments matching the type of establishment, displaying selectable directions to the plurality of establishments, receiving a user selection of a selectable direction to a desired establishment from the list of the plurality of establishments, and displaying the selectable direction to the desired establishment.

Aspects of the present disclosure include a vehicle telematics system having a memory, a communications device, and one or more processors configured to perform the functions of receiving a search request to locate a type of establishment, generating a list of a plurality of establishments matching the type of establishment, displaying selectable directions to the list of the plurality of establishments, receiving a user selection of a selectable direction to a desired establishment from the list of the plurality of establishments; and displaying the selectable direction to the desired establishment.

Aspects of the present disclosure include a computer readable medium storing computer-executable instructions that, when executed by one or more processors of a computer, cause the computer to perform the method comprising receiving a search request to locate a type of establishment, generating a list of a plurality of establishments matching the type of establishment, displaying selectable directions to the list of the plurality of establishments, receiving a user selection of a selectable direction to a desired establishment from the list of the plurality of establishments, and displaying the selectable direction to the desired establishment.

### BRIEF DESCRIPTION OF THE DRAWINGS

The novel features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advantages thereof, will be best understood by reference to the following detailed description of illustrative aspects of the disclosure when read in conjunction with the accompanying drawings, wherein:

FIG. 1 illustrates a schematic view of an example operating environment of a telematics system in accordance with aspects of the present disclosure;

FIG. 2 illustrates an example network for managing the telematics system;

FIG. 3 illustrates an example of a method of providing navigation directions to a driver of a vehicle;

FIG. 4 illustrates another example of a method of providing navigation directions to a driver of a vehicle;

FIG. 5 illustrates an example graphical user interface providing navigation directions; and

FIG. 6 illustrates an example of a computer system for carrying out the functionalities described herein.

### DETAILED DESCRIPTION

The following includes definitions of selected terms employed herein. The definitions include various examples and/or forms of components that fall within the scope of a term and that may be used for implementation. The examples are not intended to be limiting.

A “processor,” as used herein, processes signals and performs general computing and arithmetic functions. Signals processed by the processor may include digital signals, data signals, computer instructions, processor instructions, messages, a bit, a bit stream, or other computing that may be received, transmitted and/or detected.

A “bus,” as used herein, refers to an interconnected architecture that is operably connected to transfer data between computer components within a singular or multiple systems. The bus may be a memory bus, a memory controller, a peripheral bus, an external bus, a crossbar switch, and/or a local bus, among others. The bus may also be a vehicle bus that interconnects components inside a vehicle using protocols, such as Controller Area network (CAN), Local Interconnect Network (LIN), among others.

A “memory,” as used herein may include volatile memory and/or non-volatile memory. Non-volatile memory may include, for example, ROM (read only memory), PROM (programmable read only memory), EPROM (erasable PROM) and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDR SDRAM), and/or direct RAM bus RAM (DRRAM).

An “operable connection,” as used herein may include a connection by which entities are “operably connected”, is one in which signals, physical communications, and/or logical communications may be sent and/or received. An operable connection may include a physical interface, a data interface and/or an electrical interface.

A “vehicle,” as used herein, refers to any moving vehicle that is powered by any form of energy. A vehicle may carry human occupants or cargo. The term “vehicle” includes, but is not limited to: cars, trucks, vans, minivans, SUVs, motorcycles, scooters, ATVs, boats, personal watercraft, and aircraft. In some cases, a motor vehicle includes one or more engines.

An on-board telematics system may enable a driver to remotely obtain vehicle information and control his vehicle via a wireless network. Repeated access to the telematics systems may become costly, however, as some wireless carriers may charge the driver on a per-use or per-minute basis. When using a telematics system with access to wireless networks via multiple carriers, a driver may communicate routine information over a network by a carrier with a slower connection and time-sensitive information over another network by carrier with a faster connection.

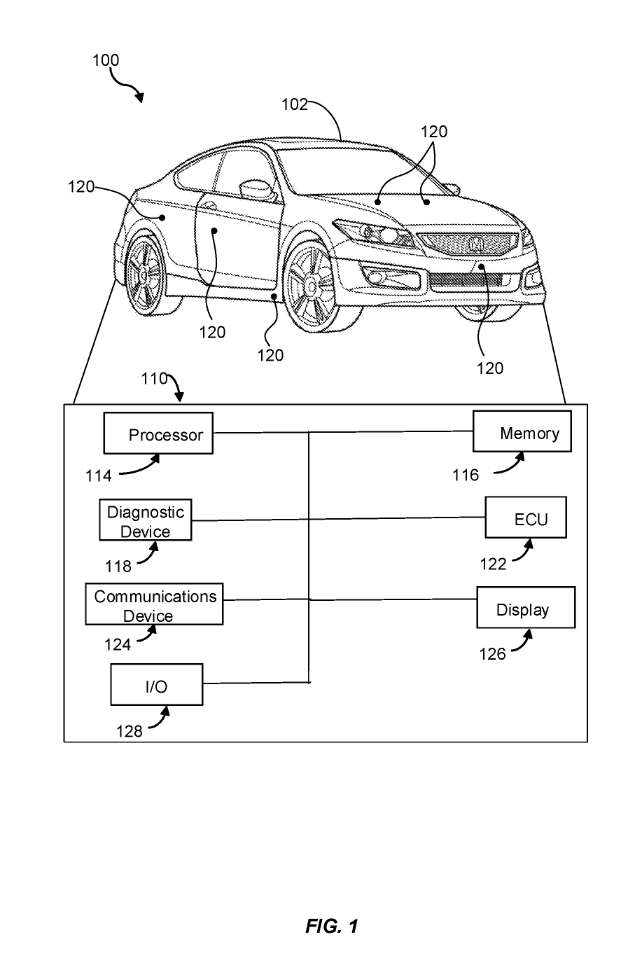

Turning to FIG. 1, a schematic view of an example operating environment 100 of a vehicle telematics system 110, according to an aspect of the disclosure, is provided. The vehicle telematics system 110 may reside within a vehicle 102. The components of the vehicle telematics system 110, as well as the components of other systems, hardware architectures, and software architectures discussed herein, may be combined, omitted or organized into various implementations. The vehicle telematics system 110 may include a processor 114 and a memory 116. The processor 114 may perform, along with the memory 116, aspects of the present disclosure relating to navigating using contextual analysis described below. The memory 116 may store temporary (e.g. cache) and/or permanent information relating to the contextual analysis.

The vehicle 102 may generally include an electronic control unit (ECU) 122 that operably controls a plurality of vehicle systems. The vehicle systems may include, but are not limited to, the vehicle telematics system 110, among others, including vehicle HVAC systems, vehicle audio systems, vehicle video systems, vehicle infotainment systems, vehicle telephone systems, vehicle control systems, and the like.

The vehicle 102 may further include a communications device 124 (e.g., wireless modem) for providing wired or wireless computer communications utilizing various protocols to send/receive electronic signals internally with respect to features and systems within the vehicle 102 and with respect to external devices. These protocols may include a wireless system utilizing radio-frequency (RF) communications (e.g., IEEE 802.11 (Wi-Fi), IEEE 802.15.1 (Bluetooth®)), a near field communication system (NFC) (e.g., ISO 13157), a local area network (LAN), a wireless wide area network (WWAN) (e.g., cellular) and/or a point-to-point system. Additionally, the communications device 124 of the vehicle 102 may be operably connected for internal computer communication via a bus (e.g., a CAN or a LIN protocol bus) to facilitate data input and output between the electronic control unit 122 and vehicle features and systems. In an aspect, the communications device 124 may be configured for vehicle-to-vehicle (V2V) communications. For example, V2V communications may include wireless communications over a reserved frequency spectrum. As another example, V2V communications may include an ad hoc network between vehicles set up using Wi-Fi or Bluetooth®.

In some implementations, the vehicle telematics system 110 may include a diagnostic device 118 and one or more sensors 120. The diagnostic device 118 may obtain information from the sensors 120. The sensors 120 may be disposed throughout the vehicle 102, and collect information such as fuel quantity, fuel range, speedometer reading, odometer reading, door locks status, global positioning system (GPS) data, entertainment system data, tire pressure reading, battery reading, fluid level, and other information relevant to the operation of the vehicle 102.

In certain implementations, vehicle telematics system 110 may include a display 126 and Input/Output devices (I/O) 128. The display 126 may include touch-sensitive screen and/or a liquid crystal display, an organic light emitting diode display, a light emitting diode display, or a fluorescent display. The I/O 128 may include a speaker, a microphone, a physical keyboard, a keypad, or a virtual keyboard disposed in the touch-sensitive screen of the display 126.

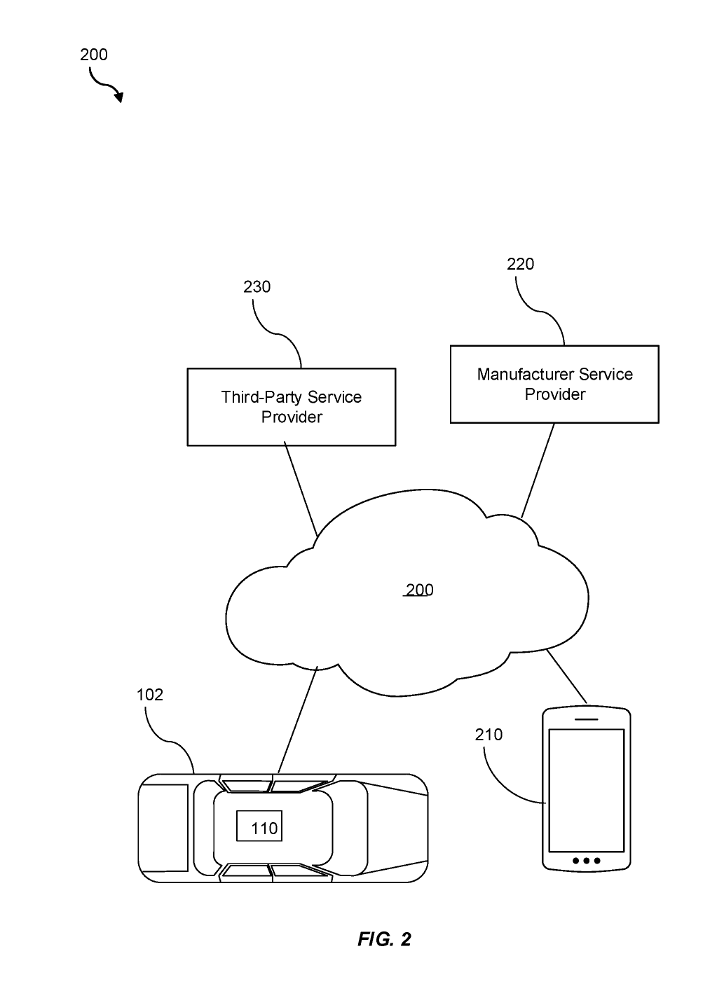

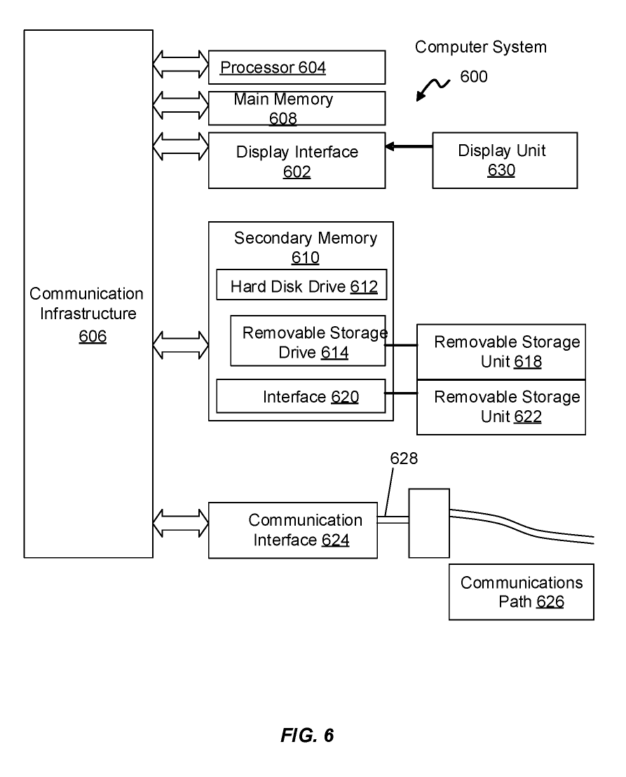

FIG. 2 illustrates an example network 200 for communicating with the telematics system 110. The network 200 may be a communications network that facilitates communications among multiple systems. For example, the network 200 may include the Internet or another Internet Protocol (IP) based network. The network 200 may enable the telematics system 110 to communicate with a mobile device 210, a manufacturer service provider 220, or a third-party service provider 230. The telematics system 110 within the vehicle 102 may communicate with the network 200 via the communications device 124. The manufacturer service provider and the third-party service provider 220, 230 may each include a computer system, as shown with respect to FIG. 6 described below, associated with one or more vehicle manufacturers, one or more telematics system manufacturers, dealers, streaming service providers, and/or internet service providers. In some examples, the manufacturer service provider 220 may belong to the one or more vehicle manufacturers. The third-party service provider 230 may belong to a third-party entity.

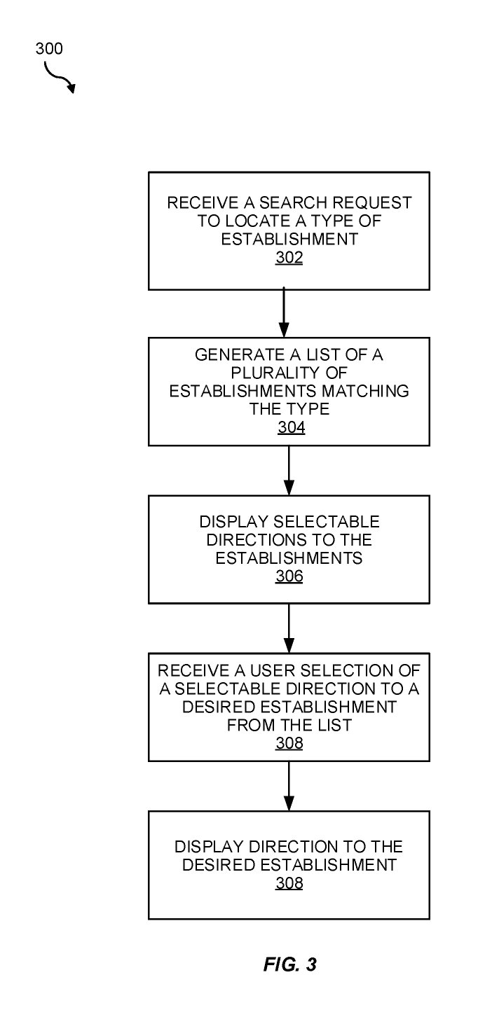

Referring to FIG. 3, in some implementations, the method 300 may illustrate an example of providing navigation directions to a driver of the vehicle 102. The method 300 may receive (302) a search request to locate a type of establishment. For example, the vehicle telematics system 110 may receive (302) a search request to locate a nearby seafood restaurant. Other types of establishment may include a gas station, a school, a post office, a grocery store, or a church, among other types of establishment. The driver of the vehicle 102 may enter the search request as text via a physical or digital keyboard associated with the vehicle telematics system 110. Alternatively, the driver may provide the search request via an audio input.

Next, the method 300 may generate (304) a list of a plurality of establishments matching the type. For example, the vehicle telematics system 110 may generate (304) a list of ten local seafood restaurants in response to the search request. The restaurants may be within a certain number of miles from the location of the vehicle 102. When generating (304) the list of restaurants, the vehicle telematics system 110 may eliminate other types of restaurants such as fast-food restaurants, steakhouses, smoothie bars, and ice cream shops, among others. In certain examples, the vehicle telematics system 110 may relay the search request to a third party search engine and use the results of the third party search engine to generate (304) the list of restaurants. In other examples, the vehicle telematics system 110 may identify the ten local seafood restaurants by searching in a local database stored within the memory 116 or a remote database at the manufacturer service provider 220. In some examples, the vehicle telematics system 110 may generate (304) the list of ten local seafood restaurants by sending the search request to the manufacturer service provider 220, and rely on the manufacturer service provider 220 to obtain the results from the search request.

Next, the method 300 may display (306) selectable directions to the plurality of establishments. For example, the vehicle telematics system 110 may display (306) selectable directions to the ten local seafood restaurants. The selectable directions may indicate drivable routes to the seafood restaurants. In some examples, the vehicle telematics system 110 may display selectable directions indicating the fastest or shortest routes to the restaurants.

The method 300 may receive (308) a user selection of a selectable direction to a desired establishment from the list of the plurality of establishments. For example, the vehicle telematics system 110 may receive (308) a user selection of a selectable direction to one of the ten local seafood restaurants from the list. The user may provide the user selection via a touch input, mouse input, or audio input, among other types of input. In some examples, the user may tap the selectable direction of the desired establishment on the touchscreen of the display 126 to select the desired establishment. In other examples, the user may provide audio input to select the desired establishment.

The method 300 may display (310) the selectable direction to the desired establishment. For example, the vehicle telematics system 110 may display (310) the selected direction to the selected local seafood restaurant. In some examples, the direction may be the quickest route to the restaurant. In other examples, the direction may be the shortest route to the restaurant. Alternatively, the direction may be a route that avoids tolls. In some implementations, the user may input the route preference (e.g. shortest, quickest . . . ) into the vehicle telematics system 110. In other implementations, the vehicle telematics system 110 may display alternative routes to the desired establishment. The alternative routes may be provided to avoid tolls, traffic accidents, and/or construction. In certain examples, the vehicle telematics system 110 may provide a textual or audio turn-by-turn navigation to the desired establishment.

In some implementations, the vehicle telematics system 110 may optionally receive additional user input to modify the list of the plurality of establishments. For example, the vehicle telematics system 110 may receive from the driver of the vehicle 102 criteria to narrow the list, such as the type of cuisine (e.g., Thai, Lebanese, and/or Peruvian), price range, distance, and ratings, among other factors. In response to the criteria input by the driver, the vehicle telematics system 110 may generate a modified list of a plurality of establishments. For example, the vehicle telematics system 110 may generate a modified list of local Thai restaurants.

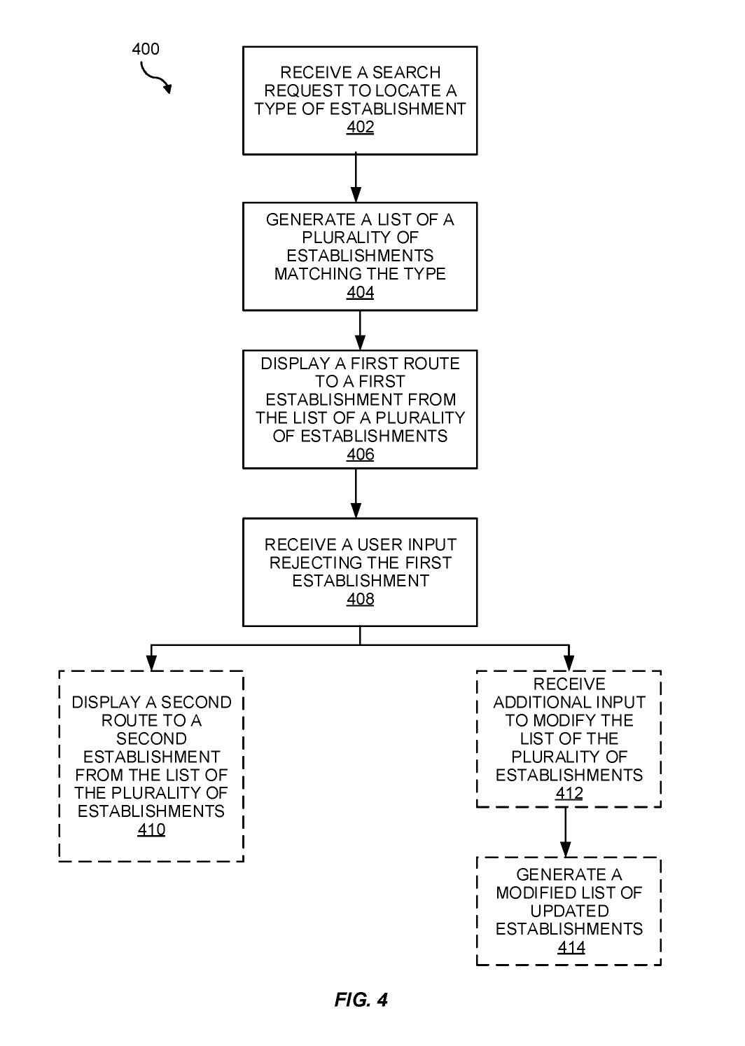

Referring to FIG. 4, in some implementations, the method 400 illustrates an example of providing navigation directions to a driver of the vehicle 102. The method 400 may receive (402) a search request to locate a type of establishment. For example, the vehicle telematics system 110 may receive (402) a search request to locate a nearby seafood restaurant. Other types of establishment may include a gas station, a school, a post office, a grocery store, or a church, among other types of establishment. The driver of the vehicle 102 may enter the search request as text via a physical or digital keyboard associated with the vehicle telematics system 110. Alternatively, the driver may provide the search request via an audio input.

Next, the method 400 may generate (404) a list of a plurality of establishments matching the type. For example, the vehicle telematics system 110 may generate (404) a list of ten local seafood restaurants in response to the search request. The restaurants may be within a certain number of miles from the location of the vehicle 102. When generating (404) the list of restaurants, the vehicle telematics system 110 may eliminate other types of restaurants such as fast-food restaurants, steakhouses, smoothie bars, and ice cream shops, among others. In certain examples, the vehicle telematics system 110 may relay the search request to a third party search engine and use the results of the third party search engine to generate (404) the list of restaurants. In other examples, the vehicle telematics system 110 may identify the ten local seafood restaurants by searching in a local database stored within the memory 116 or a remote database at the manufacturer service provider 220. In some examples, the vehicle telematics system 110 may generate (404) the list of ten local seafood restaurants by sending the search request to the manufacturer service provider 220, and rely on the manufacturer service provider 220 to obtain the results from the search request.

Next, the method 400 may display (406) a first route to a first establishment from the list of a plurality of establishments. For example, the vehicle telematics system 110 may display (406) a closest route to a local restaurant from the list often local restaurants. Alternatively, the vehicle telematics system 110 may display (406) a quickest route, a route without tolls, or a route that avoids a traffic accident, to the local restaurant. In some implementations, the user may input the route preference (e.g. shortest, quickest . . . ) into the vehicle telematics system 110. In other implementations, the vehicle telematics system 110 may display alternative routes to the desired establishment. The alternative routes may be provided to avoid tolls, traffic accidents, and/or construction. In certain examples, the vehicle telematics system 110 may provide a textual or an audio turn-by-turn navigation to the desired establishment.

The method 400 may receive (408) a user input rejecting the first establishment. For example, the vehicle telematics system 110 may receive (408) a user input indicating a lack of interest in the first establishment.

Next, in optional implementations, the method 400 may display (410) a second route to a second establishment from the list of the plurality of establishments. For example, the vehicle telematics system 110 may optionally display (410) a route to a second seafood restaurant.

In alternative implementations, the method 400 may optionally receive (412) additional input to modify the list of the plurality of establishments. For example, the vehicle telematics system 110 may optionally receive (412) from the driver of the vehicle 102 criteria to narrow the list, such as the type of cuisine (e.g., Thai, Lebanese, and/or Peruvian), price range, distance, and ratings, among other factors.

Next, in response to the criteria input by the driver, the method 400 may optionally generate (414) a modified list of a plurality of establishments. For example, the vehicle telematics system 110 may generate (414) a modified list of local Thai restaurants.

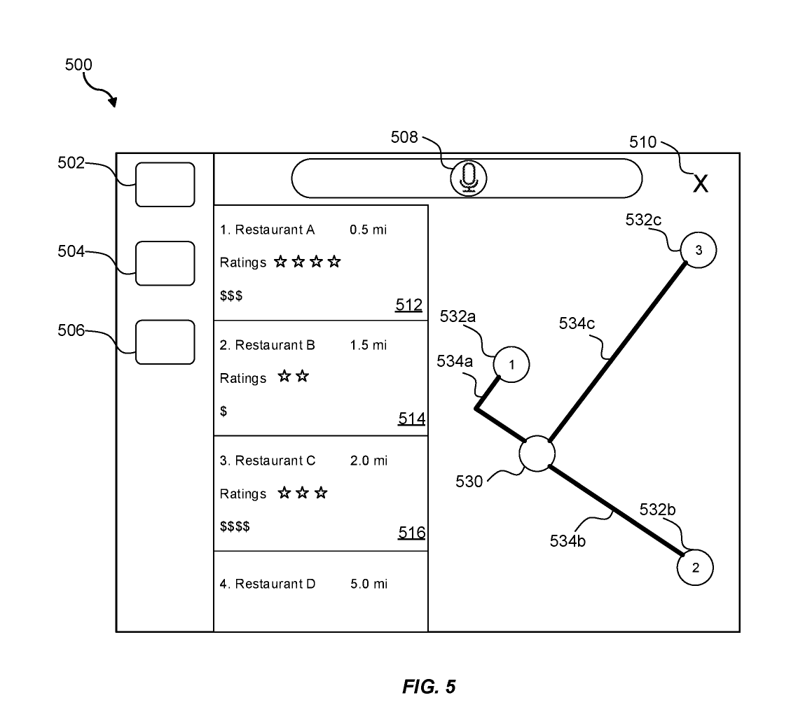

Referring to FIG. 5, an example of graphical user interface (GUI) 500 for navigation on a display 126. The GUI 500 includes input buttons (physical or touchscreen) 502, 504, 506 for selecting features such as search, map, music, navigation, and phone. The GUI 500 includes an audio input 508 for voice command and audio input, and a close button 510.

During navigation, the GUI 500 may display restaurant information 512, 514, 516, each including a name of the restaurant, a distance from the vehicle 102, a rating (e.g., number of stars) indicating the popularity of the restaurant, and a price range of the restaurant, among other information. The GUI 500 may also display a graphical representation of the restaurants with respect to the vehicle. Specifically, the GUI 500 may display location 530 of the vehicle and locations 532a-c the restaurants, and the driving routes 534a-c to the locations of the restaurants.

Aspects of the present disclosure may be implemented using hardware, software, or a combination thereof and may be implemented in one or more computer systems or other processing systems. In an aspect of the present disclosure, features are directed toward one or more computer systems capable of carrying out the functionality described herein. An example of such a computer system 600 is shown in FIG. 6.

Computer system 600 includes one or more processors, such as processor 604. The processor 604 is connected to a communication infrastructure 606 (e.g., a communications bus, cross-over bar, or network). Various software aspects are described in terms of this example computer system. After reading this description, it will become apparent to a person skilled in the relevant art(s) how to implement aspects of the disclosure using other computer systems and/or architectures.

Computer system 600 may include a display interface 602 that forwards graphics, text, and other data from the communication infrastructure 606 (or from a frame buffer not shown) for display on a display unit 630. Computer system 600 also includes a main memory 608, preferably random access memory (RAM), and may also include a secondary memory 610. The secondary memory 610 may include, for example, a hard disk drive 612, and/or a removable storage drive 614, representing a floppy disk drive, a magnetic tape drive, an optical disk drive, a universal serial bus (USB) flash drive, etc. The removable storage drive 614 reads from and/or writes to a removable storage unit 618 in a well-known manner. Removable storage unit 618 represents a floppy disk, magnetic tape, optical disk, USB flash drive etc., which is read by and written to removable storage drive 614. As will be appreciated, the removable storage unit 618 includes a computer usable storage medium having stored therein computer software and/or data.

Alternative aspects of the present disclosure may include secondary memory 610 and may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628, which may be electronic, electromagnetic, optical or other signals capable of being received by communications interface 624. These signals 628 are provided to communications interface 624 via a communications path (e.g., channel) 626. This path 626 carries signals 628 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 618, a hard disk installed in hard disk drive 612, and signals 628. These computer program products provide software to the computer system 600. Aspects of the present disclosure are directed to such computer program products.

Computer programs (also referred to as computer control logic) are stored in main memory 608 and/or secondary memory 610. Computer programs may also be received via communications interface 624. Such computer programs, when executed, enable the computer system 600 to perform the features in accordance with aspects of the present disclosure, as discussed herein. In particular, the computer programs, when executed, enable the processor 604 to perform the features in accordance with aspects of the present disclosure. Accordingly, such computer programs represent controllers of the computer system 600.

In an aspect of the present disclosure where the disclosure is implemented using software, the software may be stored in a computer program product and loaded into computer system 600 using removable storage drive 614, hard drive 612, or communications interface 620. The control logic (software), when executed by the processor 604, causes the processor 604 to perform the functions described herein. In another aspect of the present disclosure, the system is implemented primarily in hardware using, for example, hardware components, such as application specific integrated circuits (ASICs). Implementation of the hardware state machine so as to perform the functions described herein will be apparent to persons skilled in the relevant art(s).

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A method of providing navigation directions to a driver of a vehicle, comprising:
receiving a search request to locate a type of establishment;
generating a list of a plurality of establishments matching the type;
displaying selectable directions to each of the plurality of establishments;
receiving a user selection of a selectable direction to a desired establishment from the list of the plurality of establishments; and
displaying the selectable direction to the desired establishment.

2. The method of claim 1, further comprises:
receiving additional user input to modify the list of the plurality of establishments; and
generating a modified list of a plurality of updated establishments.

3. The method of claim 1, wherein receiving the search request includes receiving an audio input from the driver of the vehicle.

4. The method of claim 1, further comprises providing an audio turn-by-turn navigation to the desired establishment.

5. The method of claim 1, further comprises displaying alternative directions to the desired establishment after receiving the user selection of the selectable direction.

6. The method of claim 1, wherein the type of establishment includes one of a restaurant, a gas station, a grocery store, a post office, a school, and a church.

7. The method of claim 1, wherein generating the plurality of establishments includes:
sending the search request to a third-party search engine; and
receiving the list of the plurality of establishments from the third-party search engine.

8. A vehicle telematics system, comprising:
a memory;
a communications device; and
one or more processors configured to perform the functions of:
receiving a search request to locate a type of establishment;
generating a list of a plurality of establishments matching the type;
displaying selectable directions to each of the plurality of establishments;
receiving a user selection of a selectable direction to a desired establishment from the list of the plurality of establishments; and
displaying the selectable direction to the desired establishment.

9. The computer system of claim 8, wherein the one or more processors are configured to perform the functions of:
receiving additional user input to modify the list of the plurality of establishments; and
generating a modified list of a plurality of updated establishments.

10. The computer system of claim 8, further comprising a microphone configured to receive an audio input from the driver of the vehicle.

11. The computer system of claim 8, wherein the one or more processors are configured to perform the functions of providing an audio turn-by-turn navigation to the desired establishment.

12. The computer system of claim 8, wherein the one or more processors are configured to perform the functions of displaying alternative directions to the desired establishment after receiving the user selection of the selectable direction.

13. The computer system of claim 8, wherein the type of establishment includes one of a restaurant, a gas station, a grocery store, a post office, a school, and a church.

14. The computer system of claim 8, wherein generating the plurality of establishments includes:
sending the search request to a third-party search engine via the communications device; and
receiving the list of the plurality of establishments from the third-party search engine via the communications device.

15. A computer readable medium storing computer-executable instructions that, when executed by one or more processors of a computer, cause the computer to perform the method comprising:
receiving a search request to locate a type of establishment;
generating a list of a plurality of establishments matching the type;
displaying selectable directions to each of the plurality of establishments;
receiving a user selection of a selectable direction to a desired establishment from the list of the plurality of establishments; and
displaying the selectable direction to the desired establishment.

16. The computer readable medium of claim 15, further comprising instructions that, when executed by the one or more processors of the computer, cause the computer to perform the functions of:
receiving additional user input to modify the list of the plurality of establishments; and
generating a modified list of a plurality of updated establishments.

17. The computer readable medium of claim 15, further comprising instructions that, when executed by the one or more processors of the computer, cause the computer to perform the functions of providing an audio turn-by-turn navigation to the desired establishment.

18. The computer readable medium of claim 15, further comprising instructions that, when executed by the one or more processors of the computer, cause the computer to perform the functions of displaying alternative directions to the desired establishment after receiving the user selection of the selectable direction.

19. The computer readable medium of claim 15, wherein the type of establishment includes one of a restaurant, a gas station, a grocery store, a post office, a school, and a church.

20. The computer readable medium of claim 15, wherein generating the plurality of establishments includes:
sending the search request to a third-party search engine via the communications device; and
receiving the list of the plurality of establishments from the third-party search engine via the communications device.
